(19) United States
(12) Patent Application Publication
(10) Pub. No.: US 2021/0248873 A1
(43) Pub. Date: Aug. 12, 2021

(54) PROGRESSIVE JACKPOT MONITORING SYSTEMS AND METHODS

(71) Applicant: Meter Image Capturing, LLC, Las Vegas, NV (US)

(72) Inventor: Kristina Diane Schmit, Las Vegas, NV (US)

(21) Appl. No.: 17/244,929

(22) Filed: Apr. 29, 2021

Related U.S. Application Data
(63) Continuation-in-part of application No. 16/405,945, filed on May 7, 2019.
(60) Provisional application No. 62/766,867, filed on Nov. 8, 2018.

(51) Int. Cl. G07F 17/32; G06K 7/10; G06F 3/16

(52) U.S. Cl. CPC G07F 17/3258; G07F 17/3211; G06F 3/167; G07F 17/3225; G06K 7/10386; G07F 17/3223

(57) ABSTRACT

A data collection system and method for progressive values configured and enabled to facilitate the collection and reporting on progressive values associated with EGMs within a plurality of gaming operations. This data collection can be via a hand held device, a device in communication or connected with an EGM and/or overhead surveillance systems.

### CROSS-REFERENCE TO RELATED APPLICATION

This application is a continuation-in-part of U.S. Non-provisional patent application Ser. No. 16/405,945, filed May 7, 2019, which claims the priority benefit of U.S. Provisional Patent Application Ser. No. 62/766,867, filed Nov. 8, 2018, the entire contents of which are incorporated herein by reference.

### BACKGROUND OF THE INVENTION

The invention is directed to systems and methods for providing systems and methods for periodically acquiring and communicating jackpot values, and in particular, progressive jackpot values, in combination with a multi-purpose facility, such as a resort casino property. The term “casino” as it used herein is intended to cover some or all of a broad range of gaming and non-gaming offerings and services, such as entertainment, hospitality, hotel, restaurant and resort services, which are typically offered at casino establishments.

Most casinos employ various data collection systems, such as player tracking systems, and use a central casino management system for purposes of administering and managing the operation of electronic, mechanical and electromechanical gaming devices and electronic gaming machines (collectively referred to as “EGMs” hereinafter) acquired from manufacturers and offered by casinos to casino patrons. Other methods are used to track table games, such as blackjack and roulette, which may include electronic devices such as card reading shufflers, card reading shoes and bet sensing devices mounted on the tables, and monitoring of the chips in the tray or special drop box attached to the table.

Almost all casinos offer jackpot bonusing features in combination with EGMs and the table games to increase wagering and game play. Jackpot bonusing features may comprise jackpots that change, such as a progressive jackpot which increases incrementally each time a certain type and/or unit wager is received during game play of a table game or EGM. Jackpot values are promoted and displayed by display devices associated with the jackpot bonusing feature to attract players to the EGMs and/or table games offering the jackpot. As the jackpot increases, so does the player interest. Once a jackpot is won the jackpot is reseeded to a startup value.

All casino operators must monitor and report on jackpot values, often on a daily basis, to ensure compliance with regulatory requirements and the integrity of its gaming operations, among other things. Furthermore, jackpot values change over time and game play, increasing as their respective connected games are played and suddenly decreasing after being won, and then reseeded before starting to increase again. These jackpot values that are displayed to the casino patron, often times are not reported back via the resident accounting/player tracking system.

Data from jackpot bonusing features and related devices are often also not available to central systems due to the same or similar security, technical and/or regulatory issues. In addition to the data being only available locally, rather than centrally, checking all gaming devices locally rather than relying solely on information received at a central system may be required to maintain compliance with gaming regulations. Though it may be necessary, walking around a casino floor to obtain information manually from gaming devices can be a time-consuming and tedious task.

Accordingly, there is a need for systems and methods which can facilitate the capture of jackpot information locally from the gaming and/or related devices themselves, as well as resolve the deficiencies in the art, including those indicated above, among other things.

### SUMMARY OF THE INVENTION

The present disclosure is directed to systems and methods that resolve the issues cited above and others.

Some embodiments of the invention are directed to a progressive data monitoring system for use with an electronic gaming device having at least one display device configured to generate a display of a progressive amount responsive to receiving progressive data from a jackpot controller, wherein the progressive amount changes over time and is only available to be won by players of the gaming operation as of the time of the display thereof, the system comprising: a data communication device with the at least one display device and a casino management system, the casino management system being in communication with a central server and a data storage device configured to store progressive data; and a processing device configured to generate a copy of an instance of the display of the progressive amount as a digital image file, the digital image file defining a time of generation, wherein the processor facilitates the determination of the progressive amount in the instance of the display by identifying one of a “$” symbol or the word “progressive”, and subsequently identifies and converts one or more numerical values in the image area immediately adjacent thereto, the numerical values being assigned as the progressive amount, the data communication device communicating to the central server the progressive amount, the time of generation of the digital image file and an identification of the electronic gaming device.

In some embodiments, the progressive data monitoring system described above further comprises a jackpot controller in communication with the electronic gaming device to receive from the electronic gaming device one of (i) an instruction to add a monetary amount to the progressive amount displayed or (ii) an instruction to deduct a monetary amount from the progressive amount displayed, wherein the jackpot controller modifies the progressive amount displayed according to the instruction received.

Some embodiments of the invention are directed to a jackpot data monitoring method and system for use with a gaming operation associated with a jackpot bonusing feature including a jackpot display device configured to display a jackpot amount, the system comprising: a central server for recording jackpot data; an executable application stored in memory of a mobile device having a data communication device, a processor and a display, wherein responsive to actuation of the application, a user interface is displayed on the display for facilitating the receipt of jackpot data, the jackpot data including the current real-time jackpot amount displayed on the jackpot display device and the gaming operation associated therewith, and the data communication device communicating the jackpot data to the central server.

In some embodiments, the jackpot display device may comprise an independent device, a device or component included or mounted in the EGM itself, including the main display. For example, a portion of an EGM main display screen may be configured to include a field for displaying jackpot values. In some embodiments, the jackpot display device comprises a device included in a sign associated with the EGM, such as the overhead signage.

In some embodiments, the mobile device of the aforementioned system and method may be adapted and dimensioned to comprise a hand held type device, such as a smartphone, and may further includes a camera. In some embodiments, the application is configured to access the camera of the mobile device to facilitate the capture of an image of the jackpot amount displayed on the EGM or a separate jackpot display device. In some embodiments, the application is configured to process images of the jackpot amount displayed on the jackpot display device using the processing device and an optical character recognition (OCR) feature stored in memory to translate the jackpot amount and/or identification of the associated gaming operation to data processing characters, such as ASCII characters. In some embodiments, the application of the invention uses a proprietary methodology, embedded in the OCR data analysis, to report the unique identification number for the gaming operation (e.g., the EGM, table game or jackpot device) associated with the jackpot feature, as well as the jackpot and/or progressive values associated therewith.

In some embodiments, the mobile device of the aforementioned system and method further includes an audio data receiving device, such as a microphone, for receiving audio data of the jackpot amount and/or the identification of the associated gaming operation, and a voice recognition feature for facilitating receiving and translating the audio data relating to the jackpot amount and/or the associated gaming operation to data processing characters, such as ASCII characters.

Some embodiments of the invention are directed to a progressive data monitoring system for use with jackpot display devices, comprising: a central gaming server in communication with a data storage device; a mobile device including a processor, memory, camera, audio input, and a display, wherein executable code in the memory is configured to access an image taken by the camera, or the verbalized data of a progressive amount displayed on a jackpot display device, analyze the image, voice data, or manual input via the processor to automatically identify the progressive amount, receive an identification of a gaming operation associated with the jackpot display device, and communicate the progressive amount and identification of the gaming operation to the central gaming server for storing in the data storage device.

Some embodiments of the invention are configured such that the application communicates with mounted cameras or surveillance systems including cameras, such as the surveillance systems maintained by casino properties which includes mounted cameras and recording systems, and is configured to acquire the jackpot data through such communication, wherein executable code in the memory is configured to access an image taken by the surveillance system of a jackpot amount displayed on a jackpot display device, analyze the image via the processor to automatically identify the jackpot amount, receive an identification of the gaming operation associated with the jackpot amount, and communicate the jackpot amount and identification of the gaming operation to the central gaming server for storing in the data storage device. By using mounted cameras or existing surveillance systems, this embodiment of the invention is adapted and enabled to monitor jackpot data from the jackpot display devices of any gaming operations within viewing range automatically and/or upon demand.

Some embodiments of the invention are directed to a progressive data monitoring system configured to use with a gaming operation having one or more display devices, the one or more display devices displaying one or more progressive amounts associated with the gaming operation, wherein the one or more progressive amounts displayed are only available to be won by players of the gaming operation as of the time of the display thereof by the one or more display devices, the system comprising: a casino management system in communication with a central server and a data storage device configured to store progressive data; a jackpot controller in communication with the gaming operation to receive from the game operation one of (i) an instruction to add a monetary amount to the one or more progressive amounts displayed or (ii) an instruction to deduct a monetary amount from the one or more progressive amounts displayed, wherein the jackpot controller modifies the one or more progressive amounts displayed according to the instruction received; a mobile device including an executable application stored in a memory of the mobile device, the mobile device further including a data communication device, a processor and a display, wherein responsive to actuation of the application, a user interface is displayed on the display to facilitate the receipt of progressive data, the progressive data including the one or more progressive amounts associated with the gaming operation at the time of the display thereof, an identification of the time of the display thereof and an identification of the gaming operation, wherein the receipt of progressive data comprises an image in the form of a digital file, the image including the one or more progressive amounts displayed, wherein the processor facilitates the determination of the one or more progressive amounts in the image by identifying a “$” symbol and then translates the progressive amount in the image area adjacent to the identified “$” symbol to ASCII characters, the data communication device communicating the progressive data to the central server, wherein the central server stores the one or more progressive amounts in the data storage device based on the identification of the time of the display and the identification of the gaming operation.

In some embodiments of the aforementioned system, the mobile device further comprises a camera operating an optical character recognition feature stored in the memory. The application may be further configured to access the camera of the mobile device to facilitate the capture of an image of the one or more progressive amounts displayed on the one or more display devices. The application may also be further configured to access the camera of the mobile device to facilitate the capture of an image of a symbol identifying an electronic gaming machine.

In some embodiments of the aforementioned system, the identification of the gaming operation comprises an optically recognizable code.

In some embodiments of the aforementioned system, the application is configured to process a plurality of images of the one or more progressive amounts displayed on the one or more display devices using the processor and the optical character recognition feature stored in the memory, the processing of images resulting in the translation of the one or more progressive amounts into ASCII characters.

In some embodiments of the aforementioned system, the mobile device further comprises a microphone configured to receive audio.

In some embodiments of the aforementioned system, the application is further configured to access the microphone of the mobile device to facilitate the capture of audio received as the identification of the one or more progressive amounts. The application may also be further configured to access the microphone of the mobile device to facilitate the capture of audio received as the identification of the gaming operation. The application may also be configured to process audio received as the identification of the one or more progressive amounts using the processing device and a voice recognition feature stored in memory, the processing of the audio resulting in the translation of the one or more progressive amounts into ASCII characters.

Some embodiments of the invention are directed to a progressive data monitoring system for use with a gaming operation having one or more display devices, the one or more display devices displaying one or more progressive amounts associated with the gaming operation, wherein the one or more progressive amounts displayed are only available to be won by players of the gaming operation as of the time of the display thereof, the system comprising: a casino management system in communication with a central server and a data storage device configured to store progressive data; a jackpot controller in communication with the gaming operation to receive from the game operation one of (i) an instruction to add a monetary amount to the one or more progressive amounts displayed or (ii) an instruction to deduct a monetary amount from the one or more progressive amounts displayed, wherein the jackpot controller modifies the one or more progressive amounts displayed according to the instruction received; and a mobile device including an executable application stored in a memory of the mobile device, an optical character recognition feature stored in the memory, the mobile device further including a data communication device, a processor and a display, wherein responsive to actuation of the application, a user interface is displayed on the display to facilitate the receipt of progressive data, the progressive data including the one or more progressive amounts associated with the gaming operation at the time of the display thereof, an identification of the time of the display thereof and an identification of the gaming operation, wherein the receipt of progressive data comprises an image in the form of a digital file, the image including the one or more progressive amounts displayed, wherein the processor facilitates the determination of the one or more progressive amounts in the image by identifying a “$” symbol and then translates the progressive amount in the image area adjacent to the identified “$” symbol to ASCII characters, the data communication device communicating the progressive data to the central server, wherein the central server stores the one or more progressive amounts in the data storage device based on the identification of the time of the display and the identification of the gaming operation.

### BRIEF DESCRIPTION OF THE DRAWINGS

Other advantages of the invention will be readily appreciated as the same becomes better understood by reference to the following detailed description when considered in connection with the accompanying drawings. The components in the figures are not necessarily to scale, emphasis instead being placed upon illustrating the principles of the invention.

FIG. 1 is a flow diagram illustrating a process of an exemplary embodiment of the invention;

FIG. 2 is a schematic diagram illustrating some of the components of an exemplary system constructed in accordance with the invention; and

FIG. 3 is a schematic diagram illustrating some of the components of another exemplary system constructed in accordance with the invention

### DETAILED DESCRIPTION OF THE INVENTION

Reference will now be made to embodiments of apparatuses, systems, and methods for providing, operating and monitoring gaming operations with jackpot bonusing features, including capturing, collecting, communicating and/or processing of jackpot data, such as progressive jackpot values displayed on a display device of any kind, wherein each jackpot bonusing feature generally includes a jackpot controller in communication with a gaming operation or gaming device and a display device configured to display the current jackpot amount. It should be understood that the jackpot controller may have dedicated, dual or multipurpose functionality. For example, a jackpot controller may be dedicated to a wide area progressive bonus associated with gaming operations such as a group of similar EGMs. The jackpot controller may also be part of, or otherwise comprise, a game controller, that is, the jackpot controller may also be the controller for an EGM which includes a progressive jackpot bonus feature as part of the game offered by the EGM. The jackpot may be embedded into the math of the EGM without an independent jackpot controller. The jackpot controller may also comprise a table game dealer interface device, bet sensor, or EGM, and a jackpot display device configured to display a current jackpot amount. The jackpot controller may be used to change the jackpot amount displayed on the jackpot display device during game play and automatically detect, through the connection with the gaming device, the satisfaction of a preset criteria for winning the jackpot, such as achieving a specific game outcome. The jackpot amount displayed is the amount available to be won at the instant in time the preset criteria for winning the jackpot is satisfied.

Details, features, and advantages of the apparatuses, systems and methods of the invention will become further apparent in the following detailed description of embodiments thereof. Any reference in the specification to “one embodiment,” “a certain embodiment,” or any other reference to an embodiment is intended to indicate that a particular feature, structure or characteristic described in connection with the embodiment is included in at least one embodiment and may be utilized in other embodiments as well.

The functionality and principles of the embodiments disclosed herein may be implemented by or with software programs, executable instructions and applications, operating in connection with computer hardware, such as data input/output or communication devices, data processing devices, display devices and data storage devices, which may be within the same housing or independent and connected remotely. It is expected that one of ordinary skill, notwithstanding the many design choices motivated by, for example, available time, current technology, and economic considerations, when guided by the concepts and principles disclosed herein will be readily capable of generating such software and executable instructions, including instructions regarding the capture, collection, communicating and/or processing of jackpot data relating to the jackpot bonusing systems, including progressive jackpot systems, and selecting appropriate hardware with minimal experimentation. Therefore, in the interest of brevity and minimization of any risk of obscuring the principles and concepts according to this embodiment of the invention, further discussion of such software and hardware, if any, will be limited to the essentials with respect to the principles and concepts used by the preferred or exemplary embodiments.

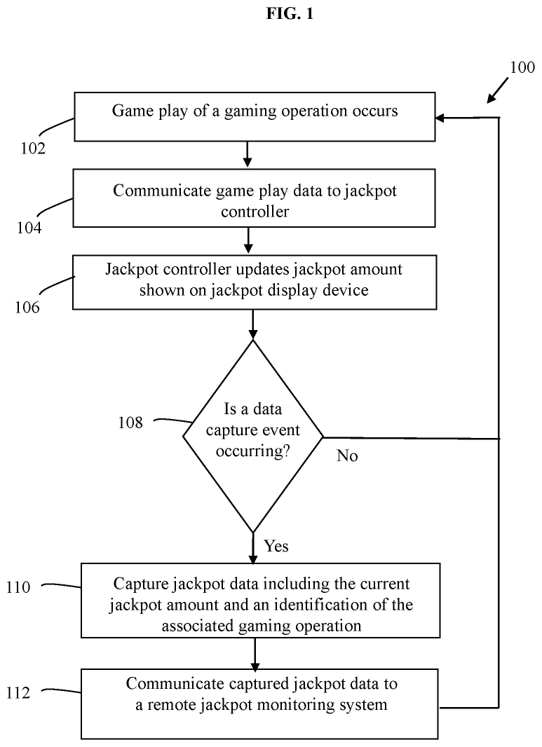

FIG. 1 illustrates an embodiment of a jackpot data capture, collection and communication system and method 100. As a result of play of a gaming operation as shown by block 102, a gaming device, such as an EGM, slot machine interface board (SMIB), circuit board, bet sensor or other data communication device, communicates game play information from the gaming operation that relates to a jackpot, such as a progressive jackpot, to an associated jackpot controller. As discussed above, the jackpot controller may be independent or part of an EGM, or the same controller which operates the game offered by the EGM which is also configured to operate a jackpot feature as a resident part in the EGM's internal math with progressive amounts are displayed within the screen of the EGM, as shown in block 104.

For example, a percentage of the EGMs “handle”, or “coin-in”, will be allocated to the progressive jackpot, and said value will increment by a defined percentage, resulting in the progressive values increase as the EGM has additional play. In another example in which the gaming operation is a table game, bet sensor may detect the placement of a wager placed on a progressive jackpot. A first portion of each such wager detected is applied to incrementally increase the jackpot amount and a second portion is used to reseed the jackpot after the jackpot amount is won. The may also communicate as shown by block 104 that all or a portion of the jackpot has been won as a result of game play in block 102.

As shown by block 106, the jackpot controller changes or updates a jackpot display displaying the current jackpot amount responsive to receiving the game play information. This system continues as shown in blocks 102-106 until a data capture event takes place as shown by blocks 108 and 110. A data capture event involves capturing jackpot data locally from either the jackpot controller or the jackpot display device. The jackpot data may include a jackpot bonusing feature identification, such as an identification of the gaming operation to which the jackpot bonusing feature relates (e.g., an EGM, table game or pit), and a jackpot value at the date and point in time at the instance of the data capture event. Alternatively, the jackpot controller may be identified which in turn can be used to identified the associated gaming operation.

It should be understood that “local” or “locally” as used herein (and as opposed to “remote” or “remotely”) is intended to mean from a position at, adjacent to, or within a general proximity of the actual jackpot gaming feature, that is, the jackpot controller and/or jackpot display device, which may comprise an EGM or other device. As shown by block 112, the captured jackpot data is communicated to a remote jackpot data monitoring system or server which may be a module of a central casino management system. The communication of jackpot data may be used for various purposes, such as for internal monitoring, game integrity, reporting and regulatory reasons.

In some embodiments, the data capture involves the use of a mobile device, or overhead surveillance camera, configured to receive the jackpot data locally from the jackpot controller, the jackpot display device or both, which may be an EGM. The receipt of data may be through any wireless connection, such as a blue tooth, WIFI, or near field communication, and the receipt and/or transmission of jackpot data may be triggered or responsive to mobile device being within a certain proximity of the jackpot controller or jackpot display device (or EGM). In other embodiments, the data capture involves the use of image and/or audio data receiving and/or recording devices, such as a camera, microphone, or via a keypad data entry, which may then be translated to data processing characters, such as ASCII characters. For example, jackpot data may be collected by authorized personnel using proprietary OCR technology to analyze an image of the jackpot display device or EGM, speaking into the mobile device's microphone, or using a data keypad entry within the application.

The mobile device may comprise a smartphone or include memory having executable code or a software application stored therein for displaying a user interface on a display device mounted on the mobile device. The user interface may be a graphical user interface (GUI) or a web-based user interface (WUI), either of which may include data entry fields and drop-down menus as appropriate. In other embodiments, the mobile device may be any device, such as a smartphone, but function as a thin client device or terminal connected to a central server when using an application constructed in accordance with the invention.

In one embodiment, the system of the invention may comprise a mobile device including a camera configured to capture still images of the jackpot display device and having customized software thereon for analyzing the image and recognizing characters in the image, such as the jackpot amount displayed on the display device.

In some embodiments, the jackpot display device may further include an identification code for the related jackpot controller and/or gaming operation, such as the EGM or table game associated with the jackpot amount. In other embodiments, the associated gaming operation is identified through the capture of another image identifying the gaming operation, such as an image of an identification code on an EGM or table.

In other embodiments, the gaming operation is identified automatically based on detection of the location of the mobile device in comparison to a gaming floor map stored in memory. The location of the mobile device may be determined by any conventional means, such as geolocation software or near field detection, with confirmation being requested through the user interface. In some embodiments, a list of potential gaming operations may be displayed through the interface of the mobile device for selection by the user. In other embodiments, the gaming operation and/or jackpot amount may be received optically, manually, or through audio recognition through the user interface.

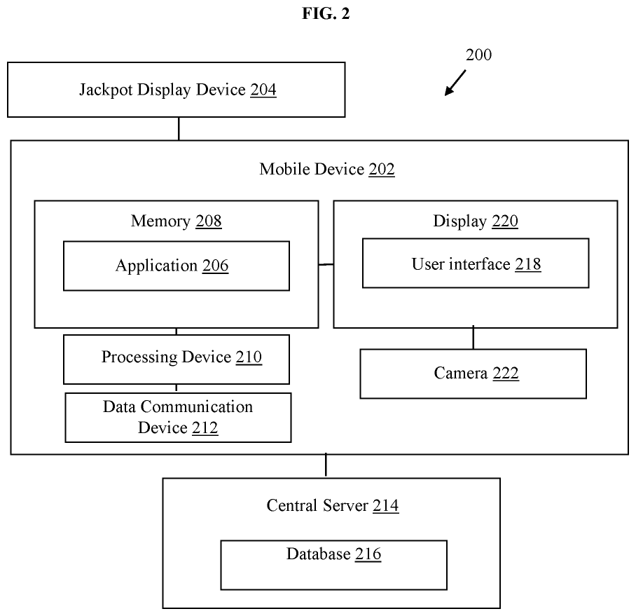

FIG. 2 illustrates a high-level schematic of a system configured in accordance with an exemplary embodiment of a system 200 for capturing jackpot data of the invention, which includes a mobile device 202 receiving jackpot data locally from a jackpot display device or EGM 204, processing the jackpot data using an application 206 stored in memory 208 and processing device 210 before being communicated via a data communication device or link 212 to a remote central server 214 for maintaining updated jackpot data in a central database 216.

In this embodiment, mobile device 202, application 206 presents a user interface 218 on a display 220 for receiving jackpot data through one or more sources, such as by including a camera 222 wherein the application 206 is configured to perform optical character recognition of the jackpot amount displayed on the jackpot display device 204 and/or the jackpot controller (not shown), EGM (not shown) or table game (not shown) associated with the jackpot amount.

Communication between the data communication device 212 and remote central server 214 may be performed via a network interface (not shown) and by way of one or more communication busses (not shown). Those busses may include, for example, a system bus, a peripheral component interface bus, and an industry standard architecture bus.

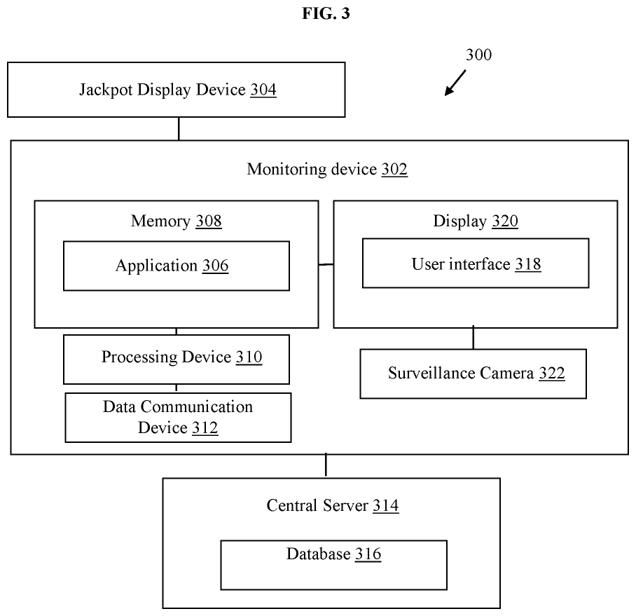

FIG. 3 illustrates a high-level schematic a system configured in accordance with an exemplary embodiment of a system 300 for capturing jackpot data of the invention, which includes a monitoring device 302, which may be a central management system or module thereof, receiving jackpot data locally from a jackpot display device or EGM 304, processing the jackpot data using an application 306 stored in memory 308 and processing device 310, before being communicated via a data communication link 312 to central server 314 for maintaining updated jackpot data in a central database 316.

In this embodiment, device 302, may include an application 306 downloaded, installed and made part of memory 308 for presenting a user interface 318 on a display 320 for initiating, setting up, modifying and automating the receiving of jackpot data through one or more sources, such as by a mobile device such as mobile device 202 and surveillance cameras 322, wherein the application 306 is configured to perform optical character recognition of the jackpot amount displayed on the jackpot display device or EGM 304 or table game (not shown) associated with the jackpot amount. Surveillance cameras 322 may include overhead cameras deployed by most casinos to monitor the gaming floor, security cameras or other mounted cameras.

In this embodiment, device 302 may reside in, or otherwise be in communication with, an EGM 304 such that application 306 enables or actuates the taking of a printscreen or screenshot (also known as a screen grab or screen capture), that is, the saving a still digital image that shows the contents of the display associated with the jackpot display device or EGM 304. The image would therefore contain the jackpot amount as of the date and time of capture, that is, the date and time associated with the image file generation, and can be communicated by device 302 to central server 314 for maintaining updated jackpot data in a central database 316. In some embodiments, device 302 is connected to a SMIB board or an interface port on jackpot display device or EGM 304, and can save a digital image and cannot impact any activity or transmission relating to the jackpot data. In some embodiments, device 302 can control, and/or resize a display on the jackpot display device or EGM 304.

The digital image or screen capture would contain progressive meter values, in addition to other characters and symbols casino operators would find value in obtaining, logging, and tabulating. Each image may be captured, and paired with specific information from the gaming device from which the image was taken. This may include information such as an identification of jackpot display device or EGM 304, location, game theme, number of progressive levels, name of individual progressives, incremented amount, reset value, capped jackpot amount, escrowed jackpot overrun, or other similar data points associated with the jackpot display device or EGM 304.

Once the image and corresponding values have been captured or ascertained by device 302, and then associated with the jackpot display device or EGM 304, the data may be processed using system 300 via methodologies such as: (i) saving the images to a database, such as central database 316, and making the images, along with corresponding jackpot display device or EGM 304 information from which the image was taken, and making these available to operators or users of system 300 for review, and the possible manual transmission of progressive values/amounts into an accounting or other monitoring system by keypad entry or voice recognition software.

It is envisioned that in some embodiments voice recognition may advantageously create efficiencies and reduce time required to populate the database with values obtained from the captured image and the corresponding machine identification data. In other embodiments, the transmission of progressive values/amounts into accounting system may occur either manually or automatically via OCR technology, as discussed herein. The OCR feature of the invention may be configured to evaluate the image, identify specific characters, and then enter such values into a database, such as the central database 316. The OCR technology may advantageously incorporate Artificial Intelligence (AI), whereby system 300 evaluates, deciphers, and subsequently processes the multiple values contained in the images obtained by device 302, associating them with the correct progressive amount embedded into the jackpot display device or EGM 304. This may also create efficiencies and reduce time required to populate database with values obtained from the captured image and the corresponding machine identification data.

Communication may be conducted via a network interface (not shown) and by way of one or more communication busses (not shown). Those busses may include, for example, a system bus, a peripheral component interface bus, and an industry standard architecture bus.

Memory 208 and 308 may include any memory device including, for example, random access memory (RAM), dynamic RAM, and/or read only memory (ROM) (e.g., programmable ROM, erasable programmable ROM, or electronically erasable programmable ROM) and may store computer program instructions and information. The memory may furthermore be partitioned into sections including program and data partition in which instructions for carrying out the functions of application are stored. The program and data partition may store program instructions that are executed by the processor.

It should be recognized that any or all of the components shown in FIG. 2 or 3 may be implemented in a single or multiple devices.

Furthermore, the order of execution or performance of the operations in the embodiments of the invention illustrated and described herein is not essential, unless otherwise specified. Thus, the operations described herein may be performed in any order, unless otherwise specified, and embodiments of the invention may include additional or fewer operations than those disclosed herein. For example, it is contemplated that executing or performing a particular operation before, contemporaneously with, or after another operation, is within the scope of aspects of the invention.

Some portions of the disclosure are presented in terms of algorithms (e.g., as represented in flowcharts, prose descriptions, or both) and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations or transformation of physical quantities or representations of physical quantities as modules or code devices, without loss of generality. However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing,” or the like, refer to the action and processes of a computer system, or similar electronic computing device (such as a specific computing machine), that manipulates and transforms data represented as physical (electronic) quantities within the computer system memories or registers or other such information storage, transmission or display devices.

It should be noted that the process steps and instructions of the embodiments can be embodied in software, firmware, or hardware, and when embodied in software, could be downloaded to reside on and be operated from different platforms used by a variety of operating systems. The embodiments can also be in a computer program product, which can be executed on a computing system.

Some embodiments also relate to an apparatus for performing the operations herein, such as a jackpot controller, mobile device, surveillance camera system and central server, among other things. Such an apparatus may be specially constructed for the purposes, e.g., a specific computer, or it may comprise a general-purpose computer selectively activated or reconfigured by a computer program stored in the computer. Such a computer program may be stored in a computer-readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be a transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for the purposes of enablement and best mode.

Those skilled in the art will appreciate that the types of software and hardware used are not vital to the full implementation of the methods of the invention. The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

While the present invention has been disclosed with reference to certain embodiments, numerous modifications, alterations, and changes to the described embodiments are possible, as exemplified by embodiments that may incorporate a computer program, mobile and web application, software module and/or database as discussed below.

### Computer Program

In some embodiments, the methods, systems, and media disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™ and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CS S). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion, Perl, Java™, JavaServer Pages (JSP), Hypertext Preprocessor (PHP), Python™, Ruby, Tcl, Smalltalk, WebDNA®, Node, React, Redux or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, Google Play Store, App Store for Palm devices, App Catalog for webOS, Windows® Marketplace for Mobile, Ovi Store for Nokia® devices, Samsung® Apps, and Nintendo® DSi Shop.

### Software Modules

In some embodiments, the methods, systems, and media disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the methods, systems, and media disclosed herein include one or more databases, or use of the same. In view of the disclosure provided herein, those of skill in the art will recognize that many databases are suitable for storage and retrieval of player and game information. In various embodiments, suitable databases include, by way of non-limiting examples, relational databases, non-relational databases, object oriented databases, object databases, entity-relationship model databases, associative databases, and XML, databases. In some embodiments, a database is internet-based. In further embodiments, a database is web-based.

In still further embodiments, a database is cloud computing-based. In other embodiments, a database is based on one or more local computer storage devices.

Although specific features of various embodiments of the invention may be shown in some drawings and not in others, this is for convenience only. In accordance with the principles of the invention, any feature of a drawing may be referenced and/or claimed in combination with any feature of any other drawing.

While exemplary apparatus, systems and methods of the invention have been described herein, it should also be understood that the foregoing is only illustrative of a few particular embodiments with exemplary and/or preferred features, as well as principles of the invention, and that various modifications can be made by those skilled in the art without departing from the scope and spirit of the invention. Therefore, the described embodiments should not be considered as limiting of the scope of the invention in any way. Accordingly, the invention embraces alternatives, modifications and variations which fall within the spirit and scope of the invention as set forth by the claims and any equivalents thereto.

1. A progressive data monitoring system for one or more electronic gaming devices having at least one display device configured to generate a display of a progressive amount responsive to receiving progressive data from a jackpot controller, wherein the progressive amount changes over time and is only available to be won by players of the gaming operation as of the time of the display thereof, the system comprising:
a data communication device with the at least one display device and a casino management system, the casino management system being in communication with a central server and a data storage device configured to store progressive data; and
a processing device configured to generate a copy of an instance of the display of the progressive amount as a digital image file, the digital image file defining a date and a time based on a date and a time associated with the creation of the digital image file, wherein the processor facilitates the determination of the progressive amount in the instance of the display by identifying one of a “$” symbol or the word “progressive”, and subsequently converts one or more numerical values in the image area immediately adjacent thereto, the one or more numerical values being assigned as the progressive amount at the time of creation, the data communication device communicating to the central server the progressive amount, the time of creation of the digital image file and an identification of the electronic gaming device.

2. A progressive data monitoring system as recited in claim 1, further comprising a jackpot controller in communication with the electronic gaming device to receive from the electronic gaming device one of (i) an instruction to add a monetary amount to the progressive amount displayed or (ii) an instruction to deduct a monetary amount from the progressive amount displayed, wherein the jackpot controller modifies the progressive amount displayed according to the instruction received.

3. A progressive data monitoring system configured to use with a gaming operation having one or more display devices, the one or more display devices displaying one or more progressive amounts associated with the gaming operation, wherein the one or more progressive amounts displayed are only available to be won by players of the gaming operation as of the time of the display thereof by the one or more display devices, the system comprising:
a casino management system in communication with a central server and a data storage device configured to store progressive data;
a jackpot controller in communication with the gaming operation to receive from the game operation one of (i) an instruction to add a monetary amount to the one or more progressive amounts displayed or (ii) an instruction to deduct a monetary amount from the one or more progressive amounts displayed, wherein the jackpot controller modifies the one or more progressive amounts displayed according to the instruction received; and
a mobile device including an executable application stored in a memory of the mobile device, the mobile device further including a data communication device, a processor and a display, wherein responsive to actuation of the application, a user interface is displayed on the display to facilitate the receipt of progressive data, the progressive data including the one or more progressive amounts associated with the gaming operation at the time of the display thereof, an identification of the time of the display thereof and an identification of the gaming operation, wherein the receipt of progressive data comprises an image in the form of a digital file, the image including the one or more progressive amounts displayed, wherein the processor facilitates the determination of the one or more progressive amounts in the image by identifying a “$” symbol and then translates the progressive amount in the image area adjacent to the identified “$” symbol to ASCII characters, the data communication device communicating the progressive data to the central server, wherein the central server stores the one or more progressive amounts in the data storage device based on the identification of the time of the display and the identification of the gaming operation.

4. A system as recited in claim 3, wherein the mobile device further comprises a camera operating an optical character recognition feature stored in the memory.

5. A system as recited in claim 4, wherein the application is further configured to access the camera of the mobile device to facilitate the capture of an image of the one or more progressive amounts displayed on the one or more display devices.

6. A system as recited in claim 5, wherein the application is further configured to access the camera of the mobile device to facilitate the capture of an image of a symbol identifying an electronic gaming machine.

7. A system as recited in claim 6, wherein the identification of the gaming operation comprises an optically recognizable code.

8. A system as recited in claim 6, wherein the application is configured to process a plurality of images of the one or more progressive amounts displayed on the one or more display devices using the processor and the optical character recognition feature stored in the memory, the processing of images resulting in the translation of the one or more progressive amounts into ASCII characters.

9. A system as recited in claim 3, wherein the mobile device further comprises a microphone configured to receive audio.

10. A system as recited in claim 9, wherein the application is further configured to access the microphone of the mobile device to facilitate the capture of audio received as the identification of the one or more progressive amounts.

11. A system as recited in claim 9, wherein the application is further configured to access the microphone of the mobile device to facilitate the capture of audio received as the identification of the gaming operation.

12. A system as recited in claim 11, wherein the application is configured to process audio received as the identification of the one or more progressive amounts using the processing device and a voice recognition feature stored in memory, the processing of the audio resulting in the translation of the one or more progressive amounts into ASCII characters.

13. A progressive data monitoring system for use with a gaming operation having one or more display devices, the one or more display devices displaying one or more progressive amounts associated with the gaming operation, wherein the one or more progressive amounts displayed are only available to be won by players of the gaming operation as of the time of the display thereof, the system comprising:
a casino management system in communication with a central server and a data storage device configured to store progressive data;
a jackpot controller in communication with the gaming operation to receive from the game operation one of (i) an instruction to add a monetary amount to the one or more progressive amounts displayed or (ii) an instruction to deduct a monetary amount from the one or more progressive amounts displayed, wherein the jackpot controller modifies the one or more progressive amounts displayed according to the instruction received; and
a mobile device including an executable application stored in a memory of the mobile device, an optical character recognition feature stored in the memory, the mobile device further including a data communication device, a processor and a display, wherein responsive to actuation of the application, a user interface is displayed on the display to facilitate the receipt of progressive data, the progressive data including the one or more progressive amounts associated with the gaming operation at the time of the display thereof, an identification of the time of the display thereof and an identification of the gaming operation, wherein the receipt of progressive data comprises an image in the form of a digital file, the image including the one or more progressive amounts displayed, wherein the processor facilitates the determination of the one or more progressive amounts in the image by identifying a “$” symbol and then translates the progressive amount in the image area adjacent to the identified “$” symbol to ASCII characters, the data communication device communicating the progressive data to the central server, wherein the central server stores the one or more progressive amounts in the data storage device based on the identification of the time of the display and the identification of the gaming operation.
